(19) United States
(12) Patent Application Publication
(10) Pub. No.: US 2007/0127625 A1
(43) Pub. Date: Jun. 7, 2007

(54) Flat image detector

(76) Inventor: Mathias Hornig, Erlangen (DE)

Correspondence Address: HARNESS, DICKEY & PIERCE, P.L.C., P.O.BOX 8910, RESTON, VA, 20195, US

(21) Appl. No.: 11/594,940

(22) Filed: Nov. 9, 2006

(30) Foreign Application Priority Data
Nov. 18, 2005 (DE) 10 2005 055 176.9

(51) Int. Cl. G03B 42/02; G03C 5/16

(52) U.S. Cl. 378/167

(57) ABSTRACT

In at least one embodiment, in order to provide a flat image detector with a very lightweight design in conjunction with as much mechanical protection as possible, a flat image detector is provided with a housing including a radiation entry window for the entry of an X-radiation. The radiation entry window is covered by a foil or a foil-like material that is substantially X-ray transparent.

### PRIORITY STATEMENT

The present application hereby claims priority under 35 U.S.C. §119 on German patent application number DE 10 2005 055 176.9 filed Nov. 18, 2005,the entire contents of which is hereby incorporated herein by reference.

### FIELD

The invention generally relates to a flat image detector.

### BACKGROUND

Flat image detectors have been employed for some years in digital X-ray imaging. Such a flat image detector is based on an active readout matrix, for example made from amorphous silicon (a-Si), and is precoated with an X-ray converter layer or scintillator layer, made from cesium iodide (CsI), for example. The incident X-radiation is firstly converted in the scintillator layer into visible light. The active matrix is subdivided into a multiplicity of pixel readout units with photodiodes that store this light which is, in turn, converted into electric charge and stored in a spatially resolved fashion.

An active readout matrix is likewise used in the case of a so-called directly converting flat image detector. Arranged upstream of the readout matrix is, however, a converter layer made from selenium, for example, in which the incident X-radiation is directly converted into electric charge. This charge is then stored in turn in a pixel readout unit of the readout matrix. Reference is also made to M. Spahn et al., “Flachbilddetektoren in der Rontgendiagnostik” [“flat image detectors in X-ray diagnostics”], Der Radiologe 43 (2003), pages 340 to 350 for the technical background of a flat image detector.

Flat image detectors have a housing in which the active matrix, the scintillator or direct converter and all the electronic components are embedded. The housing has a radiation entry window for the entry of the X-radiation, the radiation entry window generally being sealed by a carbon plate for protection against particles and liquids. Instead of the carbon plate on the flat image detector, it is also known to make use as protective cover of an antiscatter grid that is arranged in a carbon housing.

### SUMMARY

In at least one embodiment of the present invention, a flat image detector is provided that, in conjunction with low weight, is protected mechanically as comprehensively as possible, and additionally has as high a DQE (Detective Quantum Efficiency) as possible.

The flat image detector according to at least one embodiment of the invention is protected mechanically against the ingress of particles and liquids by covering the radiation entry window with a foil or a foil like material; at the same time, by contrast with carbon plates, foils or foil like materials have only a very low dead weight, and so the total weight of the flat image detector is increased only very slightly. According to at least one embodiment of the invention, the foils or foil-like materials are substantially X-ray transparent, in particular less than 5% of the incident X-radiation is absorbed; a high DQE (Detective Quantum Efficiency) is thereby achieved.

In the case of such a flat image detector according to at least one embodiment of the invention, which is covered by a foil or a foil like material, by contrast with a flat image detector that has an antiscatter grid as protection, it is easily possible to exchange or remove the antiscatter grid without thereby leaving the interior of the flat image detector unprotected.

For the purpose of a particularly good protection of the flat image detector against the ingress of liquids, the foil or the foil like material is advantageously connected to the housing in a waterproof fashion. According to one refinement of at least one embodiment of the invention, the foil or the foil like material is bonded to the housing.

It is advantageous for the foil or the foil like material to be formed from a plastic, in particular from polyurethane, polyester or polyamide, for the purpose of a particularly good thermostability and tear strength. It is particularly advantageous in this context to use a film-foil, that is to say a foil such as is normally used as base material for radiographic films. Such a film-foil consists, for example, of a polyester plastic coated with silver and is 0.3 mm thick.

According to a further refinement of at least one embodiment of the invention, the foil or the foil like material is blackened. It is thereby possible to prevent visible radiation from causing falsification of the X-ray image.

According to a further refinement of at least one embodiment of the invention, a protective cover that can be detachably connected to the housing is arranged upstream of the foil or the foil like material in the direction of the X-radiation for the purpose of protecting the flat image detector particularly effectively during its transportation.

### BRIEF DESCRIPTION OF THE DRAWINGS

The invention and further advantageous refinements in accordance with features of the subclaims are explained below in more detail in the figure with the aid of schematically illustrated example embodiments, without thereby restricting the invention to these example embodiments. In the drawings:

FIG. 1 shows a cross section through a flat image detector according to an embodiment of the invention with an entry window formed as a foil;

FIG. 2 shows an X-ray system with a flat image detector according to an embodiment of the invention arranged in a Bucky table; and

FIG. 3 shows a detail from the flat image detector in accordance with FIG. 1 with an additional protective window.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

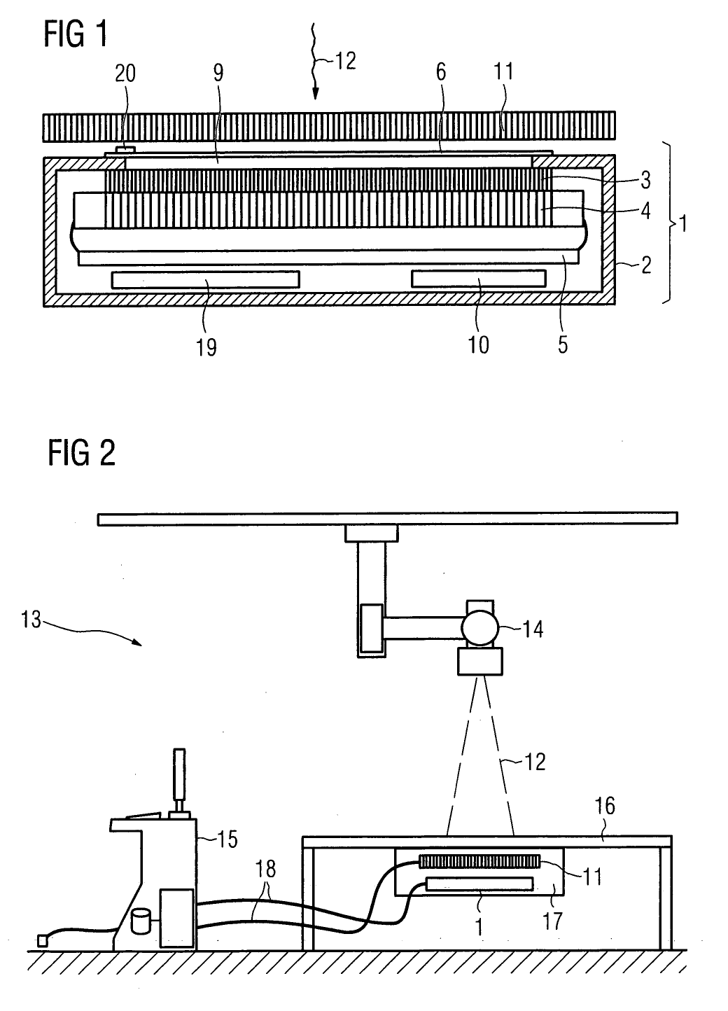

FIG. 1 shows a cross section through a flat image detector 1 according to an embodiment of the invention with a radiation entry window 9 covered by a foil 6, and an antiscatter grid 11 that is upstream in the direction of incidence of an X-radiation 12. In addition to a housing 2, the flat image detector 1 has a scintillator 3, an active matrix 4, an electronics board 5, a power supply unit 19 and a radio unit 10.

The scintillator 3 ensures the conversion of an X-radiation 12 into visible light that is subsequently converted by the active matrix 4 into charge, stored and read out for further image processing. Particularly in the case of a mobile flat image detector 1, the power supply unit 19 serves the purpose of wireless power supply, while the radio unit 10 serves the purpose of wireless data transmission to and from an X-ray system.

The foil 6 covering the radiation entry window 9 can, for example, be fastened on the scintillator 3 or—as shown in FIG. 1—on the housing 2. The foil 6 is advantageously bonded to the housing 2 in such a way that no moisture can gain ingress into the housing 2.

Within the scope of embodiments of the invention, the foil 6 or the film-foil can be formed from a plastic, for example from polyurethane, polyester or polyamide. A film-foil is understood here as a material such as is used for known radiographic films. Said materials have a high strength, for example against mechanical loads and against thermal loads, and fulfill the requirement of absorbing X-radiation only to a very slight extent.

According to a further refinement of an embodiment of the invention, the foil 6 or the foil like material is formed from a fabric, in particular gauze.

Irrespective of the material used, the flat image detector 1 is protected against the ingress of foreign bodies (for example dust particles) and liquids by the foil 6 or the foil like material.

The foil is advantageously formed from a dual chamber foil, that is to say a foil arranged in two-fold fashion with gas present between the layers. Such a dual chamber foil is particularly tear-resistant and ensures a particularly good protection against mechanical loads from outside.

According to a further refinement of an embodiment of the invention, the foil 6 or the foil like material is blackened in order to prevent the ingress of undesired radiation such as, for example, visible light, and to keep the so-called low frequency drop as slight as possible.

For the purpose of additional protection of the flat image detector 1, the foil 6 or the foil like material advantageously has at least one pressure sensor 20. By way of example, this can involve one or more point or surface sensors that are preferably arranged at the edge in relation to the active surface, for example in the region above the Dark Reference Zone (DRZ). The pressure sensor 20 can be integrated in the foil 6 or the foil like material. Moreover, the pressure sensor 20 can be connected to a control of the flat image detector 1 or of an associated X-ray imaging system, and output a warning signal in the case of an increased pressure load, or contribute to a collision protection.

Shown in FIG. 2 is an X-ray imaging system 13 that is assigned the flat image detector 1 according to an embodiment of the invention. Arranged upstream of the flat image detector 1 in the direction of the X-radiation 12 is an antiscatter grid 11 that is intended to filter out scattered radiation and thus to reduce undesired noise and artifacts on the X-ray image. The X-ray imaging system 13 further has an X-ray source 14, a control device 15 and a Bucky table 16. Both the flat image detector 1 and the antiscatter grid 11 are inserted in a Bucky drawer 17 of the Bucky table 16 and are connected to the control device 15 by way of cable connections 18.

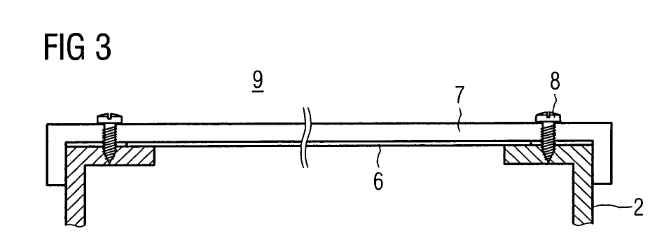

FIG. 3 shows a detail of the flat image detector 1 in accordance with FIG. 1, in the case of which a protective cover 7 suitable for transportation of the flat image detector 1 is arranged upstream of the X-ray window, designed as foil 6, in the direction of the X-radiation 12. The protective cover 7 is formed from a shockproof plastic and detachably connected to the housing. According to a further refinement of an embodiment of the invention, to this end the protective cover 7 can be connected to the housing 2 by way of screws 8.

At least one embodiment of the invention may be summarized briefly in the following way: in order to provide a flat image detector 1 with a very lightweight design in conjunction with as much mechanical protection as possible, a flat image detector 1 is provided with a housing 2 having a radiation entry window 9 for the entry of an X-radiation 12, in which the radiation entry window 9 is covered by a foil 6 or a foil-like material that is substantially X-ray transparent.

Further, elements and/or features of different example embodiments may be combined with each other and/or substituted for each other within the scope of this disclosure and appended claims.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A flat image detector, comprising:
a housing including a radiation entry window for the entry of an X-radiation, the radiation entry window being covered by at least one of a foil and a foil-like material that is substantially X-ray transparent.

2. The flat image detector as claimed in claim 1, wherein the at least one of a foil and a foil-like material is connected to the housing in a waterproof fashion.

3. The flat image detector as claimed in claim 2, wherein the at least one of a foil and a foil-like material is bonded to the housing.

4. The flat image detector as claimed in claim 1, wherein the at least one of a foil and a foil-like material is designed in such a way that less than 5% of the incident X-radiation is absorbed.

5. The flat image detector as claimed in claim 1, wherein the at least one of a foil and a foil-like material is formed from a plastic.

6. The flat image detector as claimed in claim 1, wherein the at least one of a foil and a foil-like material is formed from a film-foil.

7. The flat image detector as claimed in claim 1, wherein the at least one of a foil and a foil-like material is formed from at least one of polyurethane, polyester and polyamide.

8. The flat image detector as claimed in claim 1, wherein the at least one of a foil and a foil-like material is formed from a fabric.

9. The flat image detector as claimed in claim 1, wherein the at least one of a foil and a foil-like material is blackened.

10. The flat image detector as claimed in claim 1, wherein the at least one of a foil and a foil-like material is formed from a dual chamber foil.

11. The flat image detector as claimed in claim 1, further comprising:
a protective cover, detachably connected to the housing, arranged upstream of the at least one of a foil and a foil-like material in the direction of the X-radiation.

12. The flat image detector as claimed in claim 11, wherein the protective cover is of shockproof design.

13. The flat image detector as claimed in claim 11, wherein the protective cover is formed from plastic.

14. The flat image detector as claimed in claim 11, wherein the protective cover is screwable to the housing.

15. The flat image detector as claimed in claim 1, the at least one of a foil and a foil-like material includes at least one pressure sensor.

16. The flat image detector as claimed in claim 15, wherein the pressure sensor is integrated in the at least one of a foil and a foil-like material.

17. The flat image detector as claimed in claim 1, wherein the at least one of a foil and a foil-like material is formed from gauze.

18. The flat image detector as claimed in claim 5, wherein the at least one of a foil and a foil-like material is formed from a film-foil.

19. The flat image detector as claimed in claim 5, wherein the at least one of a foil and a foil-like material is formed from at least one of polyurethane, polyester and polyamide.

20. The flat image detector as claimed in claim 6, wherein the at least one of a foil and a foil-like material is formed from at least one of polyurethane, polyester and polyamide.
